(19) United States
(12) Patent Application Publication
(10) Pub. No.: US 2011/0072866 A1
(43) Pub. Date: Mar. 31, 2011

(54) RADIAL LOCK AND KEY FOR THE RADIAL LOCK

(76) Inventor: Miko Lee, Hsinchuang (TW)

(21) Appl. No.: 12/567,119

(22) Filed: Sep. 25, 2009

(51) Int. Cl. E05B 35/00; E05B 9/04

(52) U.S. Cl. 70/344; 70/449

(57) ABSTRACT

A radial lock has at least one outer positioning recess formed in an inner surface of a housing and at least one inner positioning recess formed in an outer surface of a lock cylinder and adjacently misaligns with the at least one outer positioning recess. A key has at least one outer boss formed in an outer surface of a driving tube and at least one inner boss formed in an inner surface of the driving tube and adjacently misaligns with the at least one outer nose. When the key is inserted into the radial lock, the at least one outer and inner bosses are respectively inserted into the at least one outer and inner positioning recesses. Numbers and relative positions of the outer and inner positioning recesses and bosses generate distinct and different combinations of radial locks and keys.

### BACKGROUND OF THE INVENTION

1. Field of the Invention

The present invention relates to a radial lock and a key, especially to a radial lock and a key that further constitute different sets of combinations with different numbers and relative positions of at least one outer and inner positioning recesses and bosses.

2. Description of the Prior Arts

A lock is commonly used to protect personal goods or private matters and only a specific key may unlock the lock.

With reference to FIG. 8, a conventional lock (30) has a housing (31), a lock cylinder (32) and multiple pins. The housing (31) has a keyhole (311), an inner surface and an outer positioning recess (312). The keyhole (311) is formed through a front end of the housing (31). The inner surface is defined around the keyhole (311). The outer positioning recess (312) is formed in the inner surface of the housing (31). The lock cylinder (32) is mounted axially in the housing (31) and has an inner positioning recess (321) formed in an outer surface of the lock cylinder (32) and aligns with and is adjacent to the outer positioning recess (312) of the housing (31). The pins are mounted in the housing (31), are arranged around the lock cylinder (32) and have different lengths.

A conventional key (40) for the conventional lock (30) has a driving tube (41), an outer boss (42) and an inner boss (43). The driving tube (41) has multiple notches (411) formed separately in and around an outer surface adjacent to a distal end of the driving tube (41) and having different depths. The outer boss (42) is formed on the outer surface adjacent to the distal end of the driving tube (41). The inner boss (43) is formed on an inner surface adjacent to the distal end of the driving tube (41) and aligns with and is adjacent to the outer boss (42).

When the driving tube (41) of the key (40) is inserted into the keyhole (311) of the housing (31), the outer boss (42) of the key (40) is inserted into the outer positioning recess (312) of the housing (31) and the inner boss (43) of the key (40) is correspondingly inserted into the inner positioning recess (321) of the lock cylinder (32). Moreover, the pins are mounted respectively in the notches (411) of the key (40) and the key (40) pushes the pins forward by different distances to unlock the lock (30).

With different lengths of the pins of the lock (30) and the notches (411) of the key (40), there are about eight hundred thousand different sets of lock (30) and key (40). However, since quantities of the lock (30) and the key (40) are increasing, more distinct combinations for locks (30) and keys (40) are required.

To overcome the shortcomings, the present invention provides a radial lock and a key for the radial lock to mitigate or obviate the aforementioned problems.

### SUMMARY OF THE INVENTION

The main objective of the present invention is to provide a radial lock and a key for the radial lock.

The radial lock has at least one outer positioning recess formed in an inner surface of a housing and at least one inner positioning recess formed in an outer surface of a lock cylinder and adjacently misaligns with the at least one outer positioning recess.

The key has at least one outer boss formed in an outer surface of a driving tube and at least one inner boss formed in an inner surface of the driving tube and adjacently misaligns with the at least one outer nose.

When the key is inserted into the radial lock, the at least one outer and inner bosses of the key are correspondingly inserted respectively into the at least one outer and inner positioning recesses of the radial lock. Numbers and relative positions of the at least one outer and inner positioning recesses and bosses gain further combinations of radial locks and keys.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of a radial lock and a key in accordance with the present invention;

FIG. 2 is an end view of a second embodiment of a radial lock in accordance with the present invention;

FIG. 3 is an end view of a second embodiment of a key in accordance with the present invention for the radial lock in FIG. 2;

FIG. 4 is an end view of a third embodiment of a radial lock in accordance with the present invention;

FIG. 5 is an end view of a third embodiment of a key in accordance with the present invention for the radial lock in FIG. 2;

FIG. 6 is an end view of a fourth embodiment of a radial lock in accordance with the present invention;

FIG. 7 is an end view of a fourth embodiment of a key in accordance with the present invention for the radial lock in FIG. 2; and

FIG. 8 is an exploded perspective view of a radial lock and a key for the radial lock in accordance with the prior art.

### DETAILED DESCRIPTION OF THE PREFERRED EMBODIMENTS

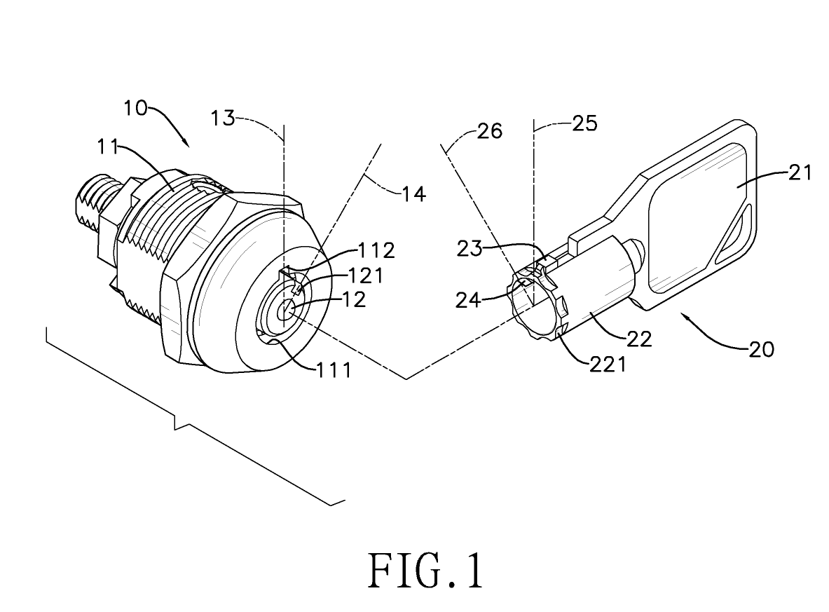

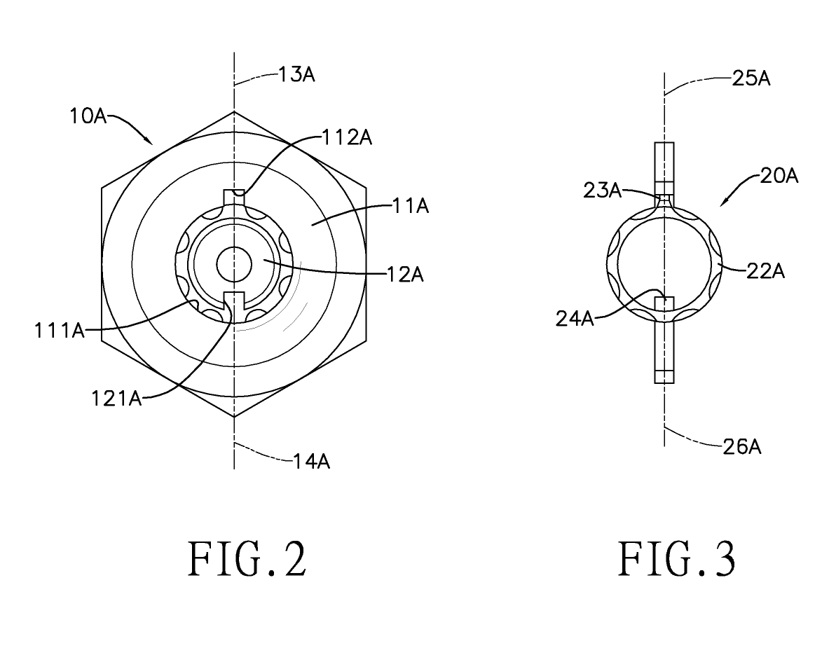

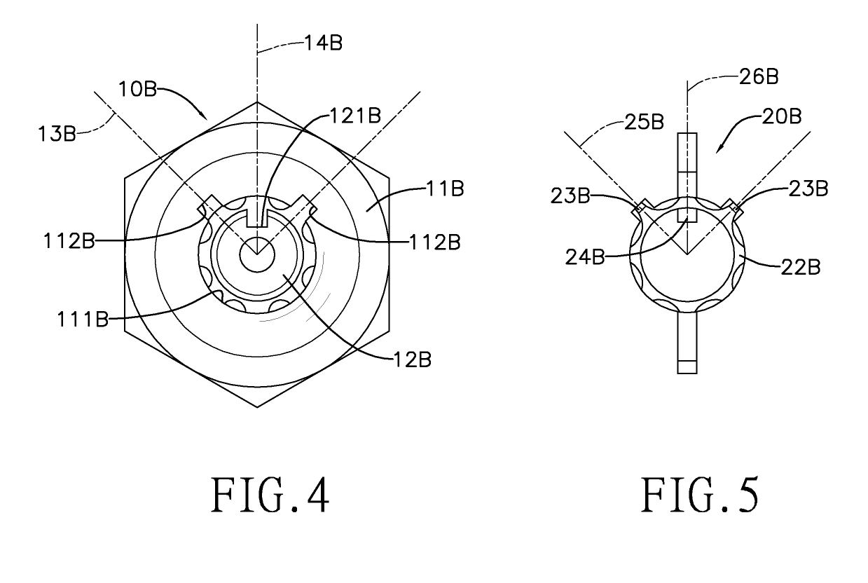

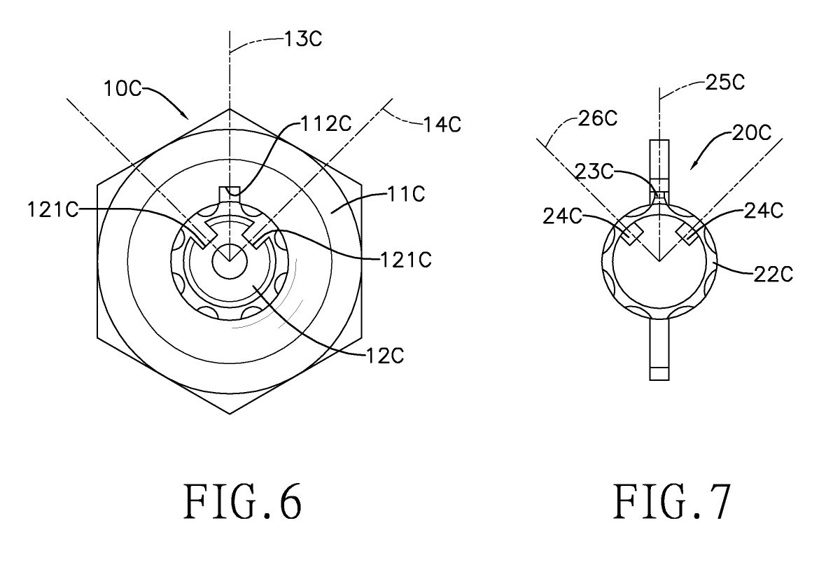

With reference to FIGS. 1, 2, 4 and 6, a radial lock (10, 10A, 10B, 10C) in accordance with the present invention comprises a housing (11, 11A, 11B, 11C), a lock cylinder (12, 12A, 12B, 12C), at least one first radial line (13, 13A, 13B, 13C) and at least one second radial line (14, 14A, 14B, 14C).

The housing (11, 11A, 11B, 11C) has a keyhole (111, 111A, 111B, 111C), an inner surface and at least one outer positioning recess (112, 112A, 112B, 112C). The keyhole (111, 111A, 111B, 111C) is formed through a front end of the housing (11, 11A, 11B, 11C). The inner surface of the housing (11, 11A, 11B, 11C) is defined around the keyhole (111, 111A, 111B, 111C). The at least one outer positioning recess (112, 112A, 112B, 112C) is formed in the inner surface of the housing (11, 11A, 11B, 11C).

The lock cylinder (12, 12A, 12B, 12C) is mounted axially in the housing (11, 11A, 11B, 11C) and has an outer surface and at least one inner positioning recess (121, 121A, 121B, 121C). The outer surface of the lock cylinder (12, 12A, 12B, 12C) is separated from the inner surface of the housing (11, 11A, 11B, 11C). The at least one inner positioning recess (121, 121A, 121B, 121C) is formed in the outer surface of the lock cylinder (12, 12A, 12B, 12C) and adjacently misaligns with the at least one outer positioning recess (112, 112A, 112B, 112C) of the housing (11, 11A, 11B, 11C).

The at least one first radial line (13, 13A, 13B, 13C) of the radial lock (10, 10A, 10B, 10C) extends through the at least one outer positioning recess (112, 112A, 112B, 112C) of the housing (11, 11A, 11B, 11C).

The at least one second radial line (14, 14A, 14B, 14C) of the radial lock (10, 10A, 10B, 10C) extends through the at least one inner positioning recess (121, 121A, 121B, 121C) of the lock cylinder (12, 12A, 12B, 12C) and is offset to the at least one first radial line (13, 13A, 13B, 13C) of the radial lock (10, 10A, 10B, 10C) between 1 and 180 degrees.

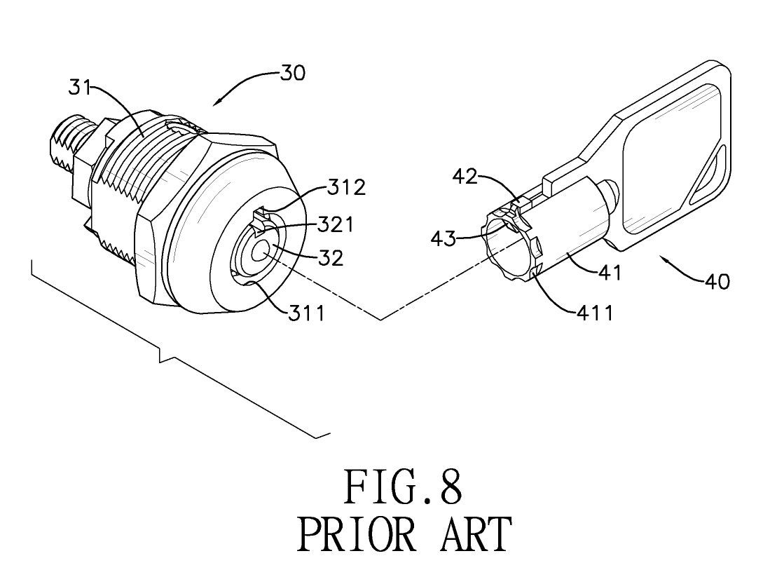

With further reference to FIGS. 3, 5 and 7, a key (20, 20A, 20B, 20C) in accordance with the present invention comprises a handle (21), a driving tube (22, 22A, 22B, 22C), at least one outer boss (23, 23A, 23B, 23C), at least one inner boss (24, 24A, 24B, 24C), at least one first radial line (25, 25A, 25B, 25C) and at least one second radial line (26, 26A, 26B, 26C).

The handle (21) allows the key (20) to be held.

The driving tube (22) is formed on and protrudes from an end of the handle (21) and has multiple notches (221). The notches (221) are formed separately in and around an outer surface of the driving tube (22) adjacent to a distal end of the driving tube (22).

The at least one outer boss (23, 23A, 23B, 23C) is formed on the outer surface of the driving tube (22, 22A, 22B, 22C) adjacent to the distal end of the driving tube (22, 22A, 22B, 22C).

The at least one inner boss (24, 24A, 24B, 24C) is formed on an inner surface of the driving tube (22, 22A, 22B, 22C) adjacent to the distal end of the driving tube (22, 22A, 22B, 22C) and adjacently misaligns with the at least one outer boss (23, 23A, 23B, 23C).

The at least one first radial line (25, 25A, 25B, 25C) of the key (20, 20A, 20B, 20C) extends through the at least one outer boss (23, 23A, 23B, 23C).

The at least one second radial line (26, 26A, 26B, 26C) of the key (20, 20A, 20B, 20C) extends through the at least one inner boss (24, 24A, 24B, 24C) and is offset to the at least one first radial line (25, 25A, 25B, 25C) of the key (20, 20A, 20B, 20C) between 1 and 180 degrees.

When the driving tube (22, 22A, 22B, 22C) of the key (20, 20A, 20B, 20C) is inserted into the keyhole (111, 111A, 111B, 111C) of the housing (11, 11A, 11B, 11C), each outer boss (23, 23A, 23B, 23C) of the key (20, 20A, 20B, 20C) is inserted into a corresponding outer positioning recess (112, 112A, 112B, 112C) of the housing (11, 11A, 11B, 11C). Each inner boss (24, 24A, 24B, 24C) of the key (20, 20A, 20B, 20C) is inserted into a corresponding inner positioning recess (121, 121A, 121B, 121C) of the lock cylinder (12, 12A, 12B, 12C). Thus, the key (20, 20A, 20B, 20C) has to be inserted into the keyhole (111, 111A, 111B, 111C) of the housing (11, 11A, 11B, 11C) at a specific angle to drive the lock cylinder (12, 12A, 12B, 12C) and unlock the radial lock (10, 10A, 10B, 10C).

The radial lock (10) and the key (20) as described have the following advantages. Numbers and relative positions of the outer and inner positioning recesses (112, 112A, 112B, 112C, 121, 121A, 121B, 121C) of the radial lock (10, 10A, 10B, 10C) and the outer and inner bosses (23, 23A, 23B, 23C, 24, 24A, 24B, 24C) of the key (20, 20A, 20B, 20C) generate different combinations apart from by variation of pins of the radial lock (10, 10A, 10B, 10C) and the notches (221) of the key (20). Therefore, more distinct keys (20) and locks (10) can be produced and sold to improve security.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A radial lock comprising
a housing having
a keyhole formed through a front end of the housing;
an inner surface defined around the keyhole; and
at least one outer positioning recess formed in the inner surface of the housing;
a lock cylinder mounted axially in the housing and having
an outer surface separated from the inner surface of the housing; and
at least one inner positioning recess formed in the outer surface of the lock cylinder and adjacently misaligning with the at least one outer positioning recess of the housing;
at least one first radial line of the radial lock extending through the at least one outer positioning recess of the housing; and
at least one second radial line of the radial lock extending through the at least one inner positioning recess of the lock cylinder and offset to the at least one first radial line of the radial lock between 1 and 180 degrees.

2. A key for a radial lock as claimed in claim 1 comprising
a driving tube;
at least one outer boss formed on an outer surface of the driving tube adjacent to a distal end of the driving tube;
at least one inner boss formed on an inner surface of the driving tube adjacent to the distal end of the driving tube and adjacently misaligning with the at least one outer nose;
at least one first radial line of the key extending through the at least one outer nose; and
at least one second radial line of the key extending through the at least one inner boss and being offset to the at least one first radial line of the key between 1 and 180 degrees.

3. The key as claimed in claim 2, wherein the driving tube further has multiple notches formed separately in and around the outer surface of the driving tube adjacent to the distal end of the driving tube.

4. The key as claimed in claim 2, wherein
the key further has a handle; and
the driving tube is formed on and protrudes from an end of the handle.

5. The key as claimed in claim 3, wherein
the key further has a handle; and
the driving tube is formed on and protrudes from an end of the handle.
